(19) United States
(12) Patent Application Publication
(10) Pub. No.: US 2008/0166691 A1
(43) Pub. Date: Jul. 10, 2008

(54) Method and Apparatus

(75) Inventors: John Calcutt Cowley, Northampton (GB); Lisa Marie Finch, Northampton (GB); Glyn Cartwright, Northampton (GB); Sanil Kumar Nair, Northampton (GB)

Correspondence Address: LUNDEEN & LUNDEEN, PLLC, PO BOX 131144, HOUSTON, TX, 77219-1144, US

(73) Assignee: BOGGLE LIMITED, Northampton (GB)

(21) Appl. No.: 11/621,198

(22) Filed: Jan. 9, 2007

(51) Int. Cl. G09B 7/00

(52) U.S. Cl. 434/322; 434/323; 434/350

(57) ABSTRACT

The present invention relates to a method 50 of evaluating commercial prospects for a product. The method comprises the step of presenting a plurality of questions to a user 52 of the method, with each question reflecting a different characteristic of the product being evaluated. The method then comprises the recording of an answer 56 given by the user to each question and the weighting of each recorded answer differently 60. The method also comprises providing an evaluation of the product to the user 64, with the evaluation being based on the plurality of differently weighted answers.

### FIELD OF THE INVENTION

The present invention relates to methods of evaluating commercial prospects for a product and apparatus for evaluating commercial prospects for a product.

### BACKGROUND TO THE INVENTION

Methods for evaluating commercial prospects for products are known. Such known methods involve a number of questions relating to a user's product being presented to the user and the recording of the answers given by the user in response to the questions. An evaluation of commercial prospects for the product is provided to the user on the basis of the recorded answers. More specifically, a conclusion is selected from a number of possible conclusions on the basis of the recorded answers and the selected conclusion is provided to the user.

The present inventors have appreciated such known methods of evaluating commercial prospects for products to have shortcomings.

It is therefore an object of the present invention to provide an improved method of evaluating commercial prospects for a product.

It is a further object of the present invention to provide an apparatus for evaluating commercial prospects for a product.

### STATEMENT OF INVENTION

The present invention has been devised in the light of the inventors' appreciation of the shortcomings of known methods of evaluating commercial prospects for products. Therefore, from a first aspect of the present invention, there is provided a method of evaluating commercial prospects for a product, the method comprising the steps of: presenting a plurality of questions to a user of the method, each question reflecting a different characteristic of the product being evaluated; recording an answer given by the user to each question; weighting each recorded answer differently; and providing an evaluation of the product to the user, the evaluation being based on the plurality of differently weighted answers.

The questions presented to the user are intended to elicit answers from the user that can be used to provide an indication of commercial prospects for the product. The questions presented and their corresponding answers relate to characteristics of the product that are expected to have a bearing on commercial prospects. For example, a question may relate to whether the product is intended for a new, a developing or an existing market. A further question may, for example, relate to the expected lifetime of the product in the marketplace. A yet further question may, for example, relate to how readily the product can be copied.

The present inventors have appreciated that different questions (and their corresponding answers) have a different bearing on commercial prospects for success of a product. Thus, the method of the present invention involves weighting each recorded answer differently. An answer is weighted in accordance with the extent to which it has a bearing on commercial prospects for success compared with the extent to which other recorded answers have a bearing on the commercial prospects.

More specifically, the method may further comprise assigning a number to each recorded answer.

More specifically, the step of weighting each recorded answer differently may comprise multiplying the number assigned to a recorded answer by a numerical weight.

Alternatively or in addition, the step of providing an evaluation of the product to the user may comprise combining the plurality of differently weighted answers.

More specifically, the step of combining the plurality of differently weighted answers may comprise summing the plurality of differently weighted answers. Thus, the summed plurality of differently weighted answers can be used to provide an evaluation of the product to the user.

Alternatively or in addition, the step of presenting a plurality of questions may comprise presenting a plurality of different answers to the user for each of the presented questions. Thus, in response to a question the user may select one of, for example, four answers. Therefore, the method may further comprise recording a selected one of the plurality of different answers.

More specifically, the plurality of different answers may have respective, different answer weights. For example, a first answer may have an answer weight of 5, a second answer may have an answer weight of 2 and a third answer may have an answer weight of 1.

More specifically, the question to which the plurality of different answers relate may have a question weight. Each question of the plurality of different questions may have a different weight. For example, a first question may have a question weight of 12, a second question may have a question weight of 2, etc.

More specifically, the method may further comprise multiplying an answer weight of a selected one of the plurality of different answers with the question weight to provide a question score for the question. Thus, the method may comprise combining (e.g. by summation) the plurality of question scores corresponding to the plurality of different questions to provide an overall score for the product. The overall score may provide a basis for the evaluation of the product.

Alternatively or in addition, the step of presenting a plurality of questions may comprise asking a user to enter a presented question score for a presented question. Thus, in response to the presented question the user may be asked to enter a presented question score between 1 and 4. The presented question score may be weighted by a presented question weight.

More specifically, the step of presenting a plurality of questions may comprise asking a user to enter a presented question score for each of a plurality of presented questions and summing the plurality of entered presented question scores. The summed presented question scores may be weighted by a presented question weight.

Alternatively or in addition, the step of presenting a plurality of questions may comprise asking a user to enter a comparison score for at least one question relating to at least one competitor. The comparison score may relate to at least one of: a competitor's product compared to the product under evaluation; and level of threat that a competitor presents in the marketplace. Thus, in response to the presented question the user may be asked to enter a comparison score between 1 and 4. The comparison score may be weighted by a comparison weight. For example, the user may be asked to enter a comparison score of: 4 if a competitor has a worse product than the product under evaluation and presents no threat to the user in the marketplace; 3 if the competitor has a better product than the product under evaluation and presents no threat to the user in the marketplace; 2 if the competitor has a better product than the product under evaluation and presents a threat to the user in the marketplace; and 1 if the competitor has a worse product than the product under evaluation and presents a threat to the user in the marketplace.

Alternatively or in addition, the plurality of questions may comprise a plurality of sets of questions (e.g. a first set of questions and a second set of questions), each of the plurality of sets of questions comprising at least two questions. The plurality of sets of questions may be associated with respective, different categories of commercial characteristics. For example, a category may be selected from the group comprising: product suitability; market attractiveness; financial requirements; promotional considerations; and implementation.

More specifically, a category may have a category weight. Each category of the plurality of different categories may have a different weight.

More specifically, a category weight may be a percentage value. For example, a first category may have a category weight of 30%, a second category may have a category weight of 10%, etc.

Alternatively or in addition, an answer to a question in a category may be weighted by the category weight. Thus, for example, when dealing with a particular answer the method may comprise multiplying an answer weight of a selected answer by a corresponding question weight and by a corresponding category weight. Thus, a category score may be determined for a particular category.

Alternatively or in addition, the method may further comprise processing a first answer to a first question and a second answer to a second question to thereby provide implicit information. The first question and the second question may be related to each other such that their answers contain implicit information, i.e. information that is not readily apparent from the first and second answers themselves. For example, the first question may relate to a market price of a product under evaluation and the second question may relate to a level of innovation of the product; or the first question may relate to a market volume for the product and the second question may relate to a gross margin for the product.

More specifically, the method may comprise presenting a plurality of different answers to the user for each of the first and second questions and recording a selected one of the presented different answers.

More specifically, the step of processing the first selected answer and the second selected answer may comprise determining an implied answer weight based on the first and second answers. Thus, the implied answer weight may form part of the evaluation of the product provided to the user, for example, by being multiplied by a category weight and a question weight to form a category score or to form part of an overall score.

More specifically, the implied answer may be determined on the basis of a look-up-table, the look-up-table having as a first axis the plurality of answers to the first question and as a second axis the plurality of answers to the second question. For example, where each of the first and second questions has three answers titled ‘low’, ‘medium’ and ‘high’, there are nine possible implied answers of which one implied answer is selected based on the answer selected by a user to the first question and based on the answer selected by the user to the second question.

Alternatively or in addition, the step of providing an evaluation of the product to the user may comprise providing an overall message to the user, the overall message being based on all answers provided by the user.

More specifically, the overall message may comprise an overall score corresponding to prospects for commercial success of the product.

More specifically, the overall score may comprise a percentage.

Alternatively or in addition, the overall message may comprise an assessment message informing the user as to whether or not to proceed with the product. For example, the assessment message may be either ‘go’ or ‘stop’.

More specifically, the assessment message may be determined based on the overall score. For example, if the overall score is less than 70%, then ‘stop’ may be displayed as the assessment message. Alternatively, for example, if the overall score is greater than or equal to 70%, then ‘go’ may be displayed as the assessment message.

Alternatively or in addition, the step of providing an evaluation of the product to the user may comprise providing a plurality of different category messages to the user, each category message being based on at least one weighted answer and each category message conveying information of a different commercial category to the user.

More specifically, the plurality of different category messages may comprise at least one of: product suitability; market attractiveness; financial requirements; promotional considerations; and implementation.

Alternatively or in addition, each of the plurality of different category messages may be based on a different combination of answers provided by the user. For example, a first set of questions answered by the user may relate to product suitability, a second set of questions answered may relate to market attractiveness, etc.

Alternatively or in addition, a category message may comprise a category score corresponding to the prospects for commercial success of the product within the scope of the commercial category in question.

More specifically, the category score may comprise a percentage.

Alternatively or in addition, the category message may comprise a category assessment message informing the user as to whether or not to proceed with the product. For example, the category assessment message may be either ‘go’ or ‘stop’.

More specifically, the category assessment message may be determined based on the category score. For example, if the category score is less than 70%, then ‘stop’ may be displayed as the category assessment message. Alternatively, for example, if the category score is greater than or equal to 70%, then ‘go’ may be displayed as the category assessment message.

Alternatively or in addition, a category message may comprise a category title identifying a category to the user.

Alternatively or in addition, a category message may comprise a category commentary conveying information on a category to the user. For example, the information conveyed by the category commentary may comprise at least one of: an explanation of the category score provided to the user; and comments on how the user may improve his current position as indicated by the category score.

More specifically, the category commentary may be determined in dependence on at least one weighted answer.

Alternatively or in addition, the step of providing an evaluation of the product to the user may comprise providing a plurality of different question messages to the user, each question message being based on an answer and each question message conveying information to the user relating to the question to which the answer has been given.

More specifically, a question message may comprise a question commentary conveying information to the user on an answer given to the question. For example, the information conveyed by the question commentary may comprise at least one of: a statement of the question asked and the answer given; comments on the answer given; and comments on how the user may improve his current position as regards the characteristic of the product under evaluation to which the question relates.

Alternatively or in addition, the method may further comprise the recording of product information. The product information may relate to information further to that recorded by way of the answers recorded by the method in response to the plurality of different questions presented to the user. For example, the product information may comprise: detailed information relating to the status of intellectual property connected with the product under evaluation; information gleaned from a market foresighting report of relevance to the product under evaluation; and financial circumstances of a legal entity that will exploit the product under evaluation.

Alternatively or in addition, the method may further comprise the step of having a person carry out an evaluation of the product.

More specifically, the person may carry out the evaluation based on at least one of: the answers recorded by the method in response to the plurality of different questions presented to the user; and recorded product information.

Alternatively or in addition, the method may further comprise the step of recording at least one personal score given by the person in dependence on the person's evaluation of the product.

More specifically, the at least one personal score may comprise at least one of: a score in respect of at least one of the plurality of different questions presented to the user; a score in respect of at least one category of commercial characteristics; a score in respect of recorded product information.

Alternatively or in addition, the method may further comprise the step of weighting the recorded at least one personal score.

More specifically, where the recorded at least one personal score has a corresponding score determined by the method in dependence on an answer recorded in response to the plurality of questions presented to the user, the personal score and the corresponding score may be weighted to different extents. For example, the corresponding score may be a category score for a particular category and the personal score may be for the particular category.

More specifically, a weighting for the corresponding score may be greater than a weighting for the personal score. For example, the corresponding score may have a weighting of 80% and the personal score may have a weighting of 20%.

Alternatively or in addition, the step of providing an evaluation of the product to the user may comprise providing an overall score to the user, the overall score comprising a combination (e.g. a summation) of at least one personal score and at least one corresponding score.

According to a second aspect of the present invention there is provided an apparatus for evaluating commercial prospects for a product, the apparatus comprising a computer processor and computer memory, the computer memory storing a plurality of questions, each question reflecting a different characteristic of a product to be evaluated, the apparatus being operative to present each of the stored plurality of questions to a user of the apparatus and to record and store in the computer memory an answer given to each question by the user, the computer processor being operative to weight each of the stored answers differently and to provide an evaluation of the product for the user based on the plurality of differently weighted answers.

More specifically, the apparatus may comprise a server apparatus and a client apparatus, the server apparatus and the client apparatus being spaced apart from each other.

More specifically, the server apparatus and the client apparatus may be configured to communicate data between them. For example, the server apparatus and the client apparatus may be configured to communicate data via the Internet.

Alternatively or in addition, the client apparatus may comprise a Personal Computer (PC).

Alternatively or in addition, the server apparatus may comprise a server processor and server memory, the server memory storing the plurality of questions, the server apparatus being operative under control of the server processor to convey each of the stored questions to the client apparatus and to receive from the client apparatus and store in the server memory an answer given to each question by the user, the server processor being operative to weight each of the stored answers differently and to convey an evaluation of the product to the client apparatus, the evaluation being based on the plurality of differently weighted answers.

Alternatively or in addition, the client apparatus may comprise a client processor, the client apparatus being operative under control of the client processor to present to the user each of the plurality of questions received from the server apparatus, to record the answer given to each question by the user, and to convey the recorded answers to the server apparatus, the client apparatus being further operative to receive an evaluation from the server apparatus and to provide the evaluation to the user.

Further embodiments of the second aspect of the present invention may comprise at least one feature of the first aspect of the present invention.

According to a third aspect of the present invention, there is provided a computer program comprising executable code that upon installation on a computer causes the computer to execute the procedural steps of: presenting a plurality of questions to a user of the computer, each question reflecting a different characteristic of the product being evaluated; recording an answer given by the user to each question; weighting each recorded answer differently; and providing an evaluation of the product to the user, the evaluation being based on the plurality of differently weighted answers.

More specifically, the computer program may be embodied on a data carrier.

Alternatively or in addition, the computer program may be stored in computer memory.

Alternatively or in addition, the computer program may be embodied in a read-only memory.

Alternatively or in addition, the computer program may be carried on an electrical carrier signal.

Alternatively or in addition, the computer may comprise a server computer and a client computer, which upon installation of the computer program are operative to execute the procedural steps.

Further embodiments of the third aspect of the present invention may comprise at least one feature of the first or second aspect of the present invention.

### BRIEF DESCRIPTION OF DRAWINGS

Further features and advantages of the present invention will become apparent from the following specific description, which is given by way of example only and with reference to the accompanying drawings, in which:

FIG. 1 is a block diagram representation of apparatus for evaluating commercial prospects for a product;

FIG. 2 is a flow chart representation of a method according to a first embodiment of the present invention;

FIG. 3 shows a preliminary set of questions asked of a user of the present invention;

FIG. 4 provides details of the different questions presented to a user of the present invention;

FIG. 5 provides details of the answers that may be given to the questions shown in FIG. 4;

FIG. 6 shows a weighting process carried out by the server apparatus;

FIG. 7a shows look up tables used in the weighting process of FIG. 6;

FIG. 7b shows weights accorded to combinations of possible answers;

FIG. 8 shows a result of combining scores for answers to the questions given to the user;

FIG. 9 shows a first part of a report shown to a user;

FIG. 10 shows a second part of the report shown to the user;

FIG. 11 shows a third part of the report shown to the user;

FIG. 12 is a flow chart representation of a method according to a second embodiment of the present invention;

FIG. 13 provides details of the different questions presented to a user of the second embodiment; and

FIG. 14 shows part of the evaluation process and the result of combining scores for answers to the questions given in use of the second embodiment.

### SPECIFIC DESCRIPTION

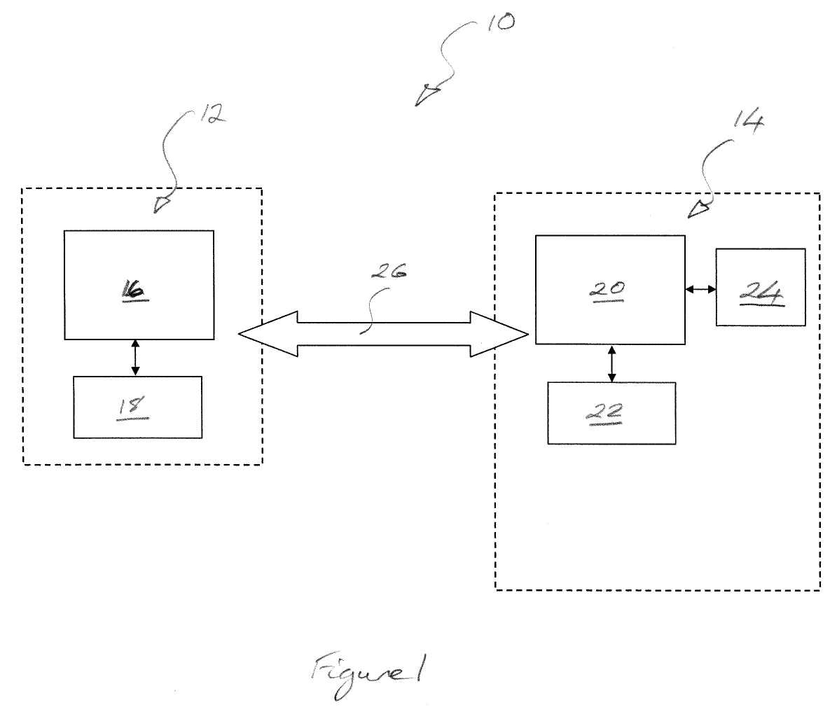

FIG. 1 is a block diagram representation of apparatus 10 for evaluating commercial prospects for a product. The term product covers anything that is potentially saleable and thus covers both goods and services. The apparatus 10 comprises a server apparatus 12 of known configuration and a client apparatus 14. The server apparatus comprises a server processor 16 and server memory 18. The client apparatus 14 comprises a client processor 20, an input device 22, such as a keyboard or mouse, and a display 24. The client apparatus 14 is constituted as a Personal Computer (PC). Communication of data between the server apparatus 12 and the client apparatus 14 and of executable programs from the server apparatus 16 to the client apparatus 14 is by means of the Internet 26.

A computer program comprising executable code is loaded into the server apparatus 12 in accordance with known practice. The computer program may be written in any appropriate programming language. The choice of programming language will be made readily by the skilled person depending on the development platform, the hardware platform on which the computer program is to be run, the program development strategy to be followed, etc. Nevertheless and despite the choice that may be exercised as regards programming language it will be within the grasp of the common general knowledge of the skilled person to make an appropriate choice and then having made such a choice to develop a computer program that is capable of executing the processes described herein. The computer program may be stored in one of a number of well known fashions, e.g. on optical or on magnetic media, and loaded into the server apparatus in accordance with well known practice. Alternatively, the computer program may be stored in the server memory 18 in a known manner, e.g. in read only memory. Upon execution of the computer program by the server processor 16, client processes, as described in more detail below, are communicated to the client apparatus via the Internet 26 for execution by the client processor 20.

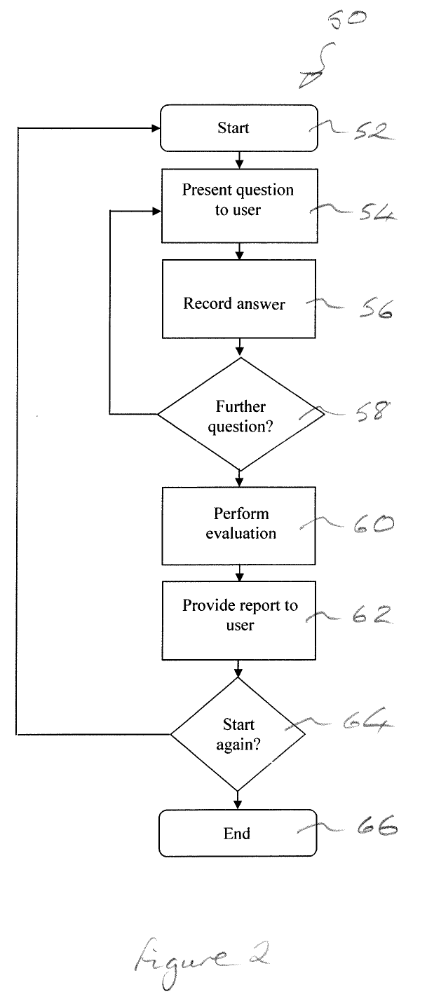

The main procedural steps of the computer program according to a first embodiment of the invention are represented in FIG. 2. The first flow chart box 52 designates the start of the method executed by the computer program. As a first operating step 54 a question relating to the product to be evaluated is presented to a user of the client apparatus 14 on the display device 24. As the computer program is resident on the server apparatus a client process to carry out this operation, and other such operations, is communicated via the Internet 26 from the server apparatus 12 to the client apparatus 14. The user operates the input device 22 to provide an answer to the question. The answer is recorded 56 by the client apparatus 14 and communicated to the server apparatus 12. The steps of presenting a question and recording an answer are repeated 58 until all the questions to be asked have been exhausted. Further details of the questions asked are described below. Next the recorded answers are evaluated 60 by the server apparatus 12 as described in more detail below. When the evaluation is complete a report is provided to the user 62 by displaying the report on the display device 24 of the client apparatus 14. Thereafter the user is offered the opportunity to repeat the process 64 or to terminate the program 66.

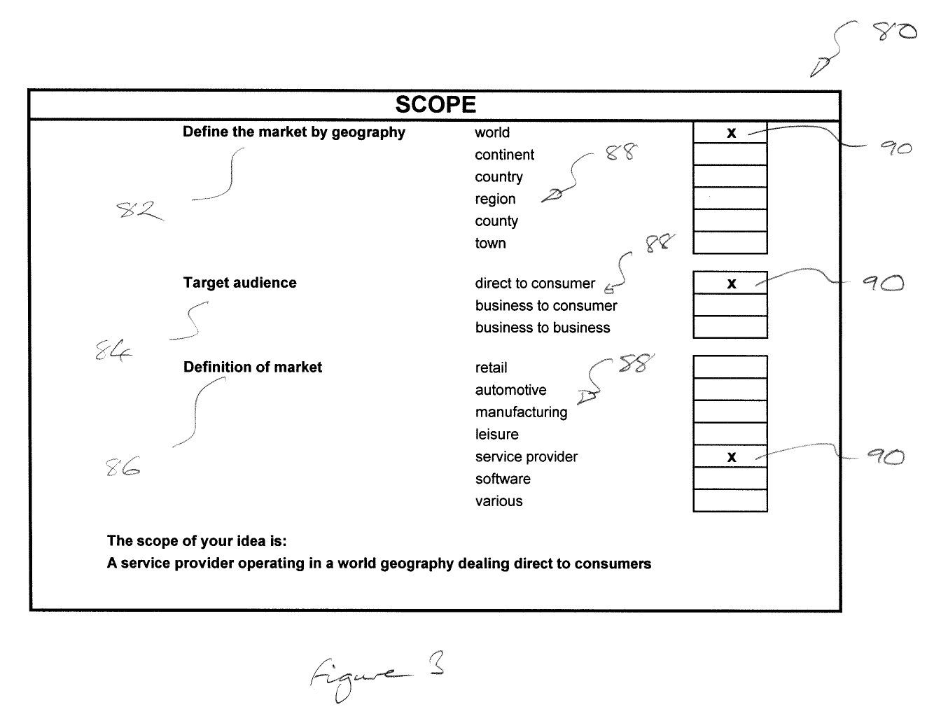

Details of the questions asked will now be provided with reference to FIGS. 3 to 5. FIG. 3 shows a preliminary set of questions asked of the user. This preliminary procedure is not represented in the flow chart of FIG. 2 but is used to define the general scope of the product being evaluated by the present invention. There are three questions: geographical extent of market 82; target market 84; and nature of market 86. The user is constrained by the computer program to indicate by means of a cross 90 which of a plurality of answers 88 to each question applies to the product being evaluated. The user places his crosses to select the appropriate answer by means of the input device 22 on the client apparatus 14. Upon conclusion of this preliminary procedure, the general scope of the product being evaluated is summarised based on the answers given and displayed to the user on the display device 24.

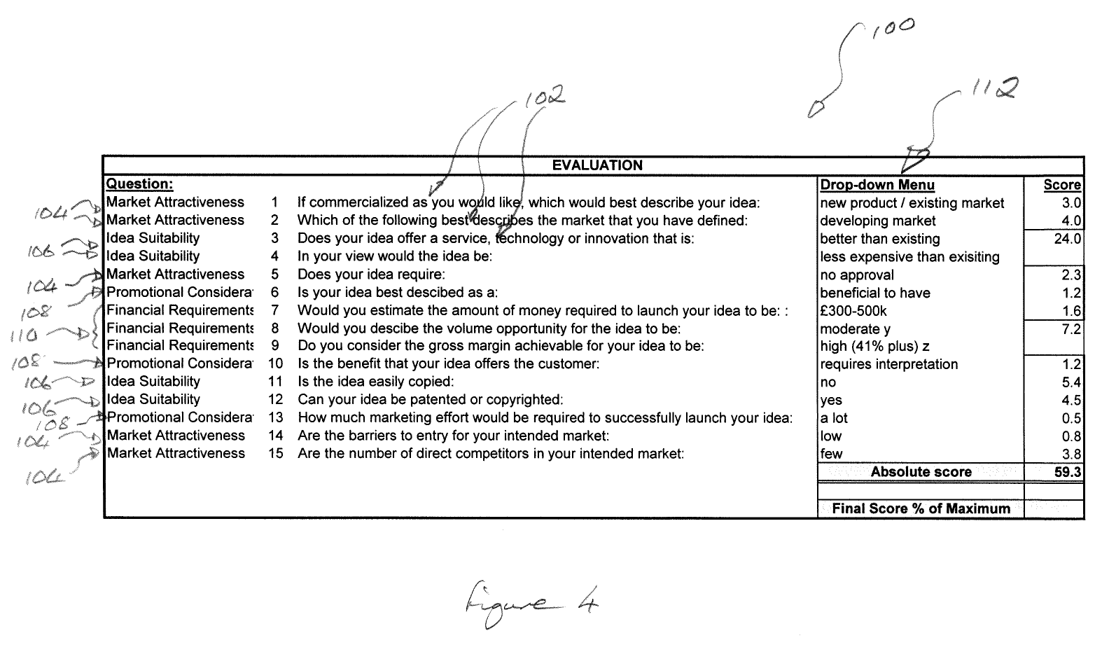

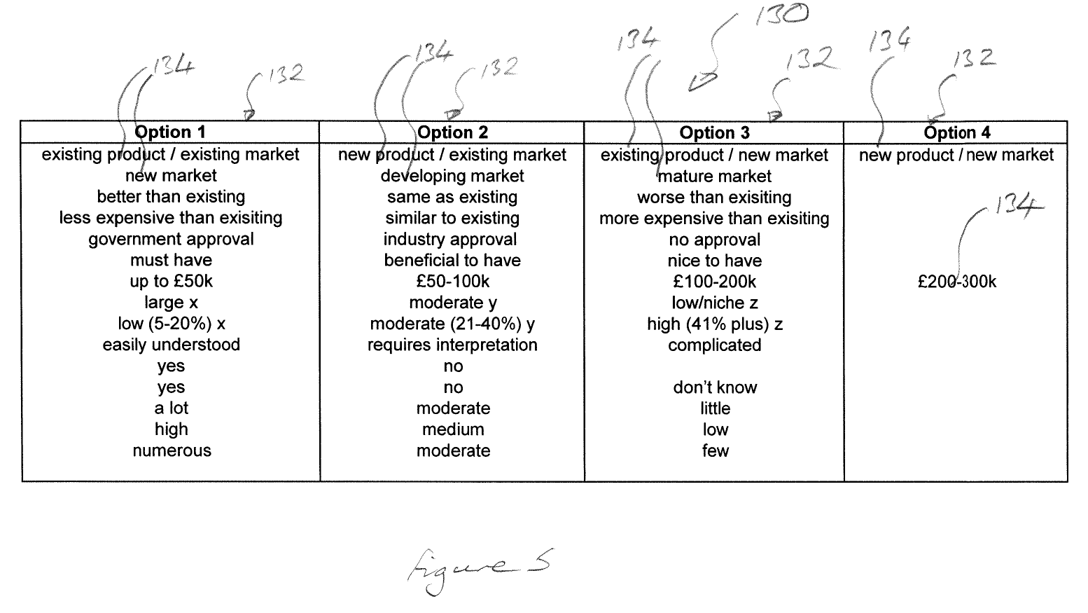

FIG. 4 provides details of the plurality of different questions presented to the user 100 (at step 54 in FIG. 2) following the completion of the preliminary procedure described above with reference to FIG. 3. Each of the questions 102 reflects a different characteristic of the product being evaluated that may have a bearing on whether or not and the extent to which the product being evaluated will be commercially successful. The questions shown in FIG. 4 are not exhaustive. In forms of the invention more than fifty such questions may be presented to the user. Each question belongs to a category of questions 104 to 110, such as market attractiveness, idea suitability, financial requirements and promotional considerations. Each category of questions relates to an aspect of commercial exploitation of a product and thus the questions in each category all have a bearing on the aspect to which the category relates. An answer to each question is given by selecting from a plurality of possible answers presented to the user in menu form 112. The plurality of possible answers is described below with reference to FIG. 5.

FIG. 5 shows the plurality of possible answers 130 that may be given to a number of different questions. In each column 132 of the table 130 shown in FIG. 5 is a list of answers 134 corresponding in turn to the questions 102 listed in the table of FIG. 4. There are four columns 132 in the table 130 of FIG. 5. Thus, as can be seen from the table 130 of FIG. 5 there are up to four possible answers 134 to each question 102 specified in the table 100 of FIG. 4. For the sake of clarity all possible answers to the questions are not shown in the table 130 of FIG. 5 with further possible answers being provided (in further columns of the table 130 of FIG. 5) depending on the question to be asked.

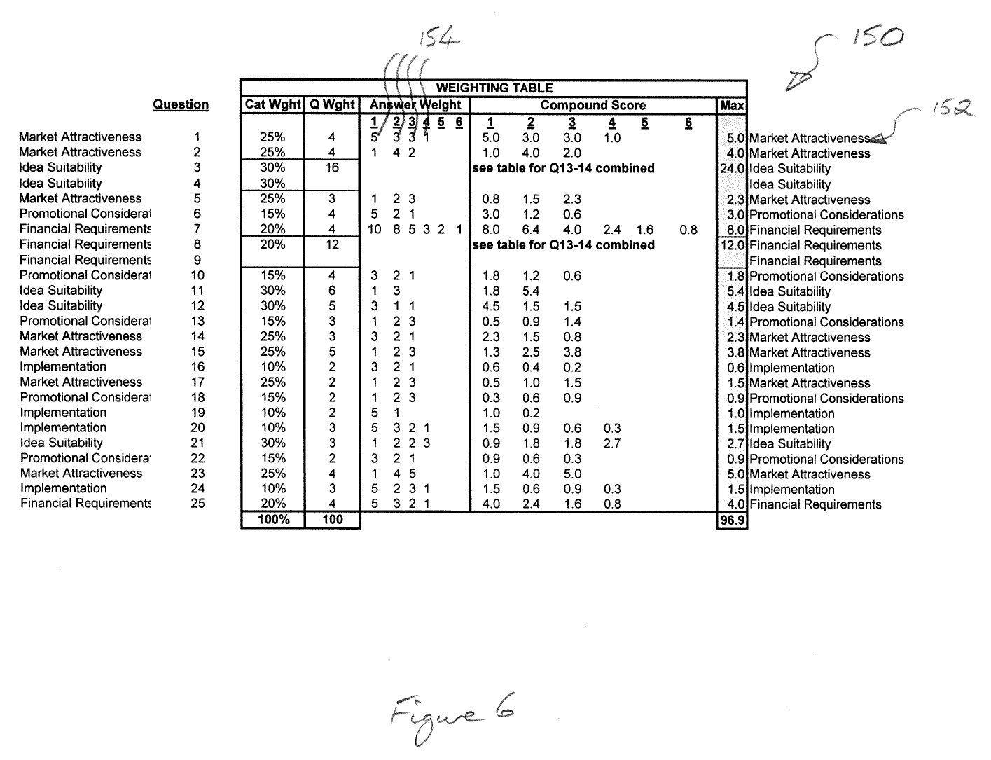

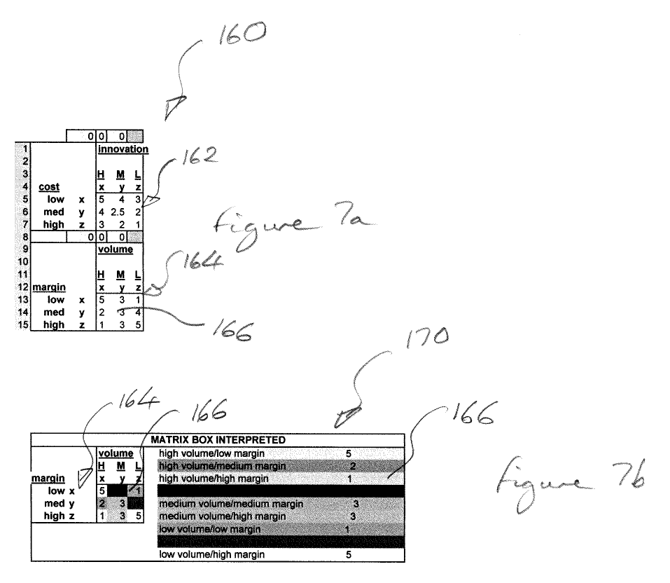

Each question 102 shown in the table 100 of FIG. 4 is presented in turn on the display 24 of the client apparatus 14 to the user 54. As mentioned above each question 102 reflects a different characteristic of the product that the user wishes to have evaluated. The user is also presented on the display with all the possible answers 134 to each question 102. The user selects the appropriate answer 134 to each question 102 by means of the input device 22, e.g. by pointing with the mouse cursor on the display at the answer to be selected and by making a selection by clicking the mouse button. Each selected answer is recorded by the client apparatus 14, 56 and communicated to the server apparatus 12 via the Internet 26. Recorded answers 134 are weighted differently and an evaluation of the product based on the answers performed in the server apparatus 12 as described below with reference to FIGS. 6, 7a and 7b.

FIG. 6 shows the weighting process carried out by the server apparatus 12, 60 in a table 150. The table 150 of FIG. 6 has the same general form as the table 100 of FIG. 4 in that the rows of the table 150 of FIG. 6 correspond in turn to the rows of the table 100 of FIG. 4. Thus each row of the table 100 of FIG. 4 and its corresponding row in the table 150 of FIG. 6 relates to a specific question. Considering the table 150 of FIG. 6 in more detail, the first row relates to the first question 102 specified in the table 100 of FIG. 4, namely “If commercialised as you would like, which would best describe your idea (product)”. As described above with reference to FIG. 5, the first question has four possible answers 134, namely: existing product/existing market, new product/existing market, existing product/new market, and new product/new market. Each of the four possible answers 134 carries an answer weight 154, namely: ‘5’, ‘3’, ‘3’ and ‘1’. Also, the question itself carries a question weight, namely ‘4’. Furthermore, the question carries a category weight, namely ‘25%’. This category weight is attributed to the category to which the question belongs, namely ‘market attractiveness’, and thus the category weight is shared by all the other questions in the ‘market attractiveness’ category. In performing the evaluation 60 in respect of the question, the server apparatus 12 multiplies the answer weight by the question weight and by the category weight to produce a score for the question. This process is repeated for each question to produce a score for each question, except as described below.

FIGS. 7a and 7b illustrate the evaluation process as carried out with respect to a first pair of questions, namely questions 3 and 4, and a second pair of questions, namely questions 8 and 9. FIG. 7a shows a first look up table 162 used in determining the weighting to be accorded to the first pair of questions and a second look up table 164 used in determining the weighting to be accorded to the second pair of questions. The process followed in respect of the first and second pairs of questions is the same and thus the process in respect of the second pair of questions will be described. The second pair of questions, namely questions 8 and 9, belong to the financial considerations category and carry a category weight of 20%. Referring to the table 100 of FIG. 4, question 8 is “Would you describe the volume opportunity for your idea (product) to be:” and question 9 is “Do you consider the gross margin for your idea (product) to be:”. As can be seen from the table 130 of FIG. 5, each of questions 8 and 9 has three possible answers 134, the answers for each being of the nature of ‘low’, ‘medium’ and ‘high’. More specifically, for question 8 the possible answers are: ‘large’, ‘moderate’ and ‘low’; and for question 9 the possible answers are: ‘low’, ‘moderate’ and ‘high’. The selected answers to questions 8 and 9 are combined by means of the second look up table 164 of FIG. 7a to provide a single answer weighting 166, which is used instead of the per question weighting process described above. As mentioned above, the same combined weighting process is applied to questions 3 and 4. Returning to the combined weighting process of questions 8 and 9, there are three possible answers to each of questions 8 and 9. This provides a total number of possible answer weights of nine, when the answer weights of the possible answers to questions 8 and 9 are combined in the two-dimensional matrix of the second look up table 164 of FIG. 7a. The weight values of the second look up table 164 are determined in accordance with the table 170 of FIG. 7b, which shows the weights accorded to all the combinations of the possible answers to questions 8 and 9. Thus, if the selected answer to question 8 is ‘high volume’ and the selected answer to question 9 is ‘low margin’ the combined answer weighting is determined on the basis of the second look up table to be ‘5’. As a further example, if the selected answer to question 8 is ‘high volume’ and the selected answer to question 9 is ‘high margin’ the combined answer weighting is determined on the basis of the second look up table to be ‘1’. When the combined weighting process is complete, whether it be for the combination of questions 8 and 9 or the combination of questions 3 and 4, the combined answer weight is multiplied by a combined question weight (i.e. a weight for questions 3 and 4 or for questions 8 and 9) and then multiplied by the category weight to produce an answer score.

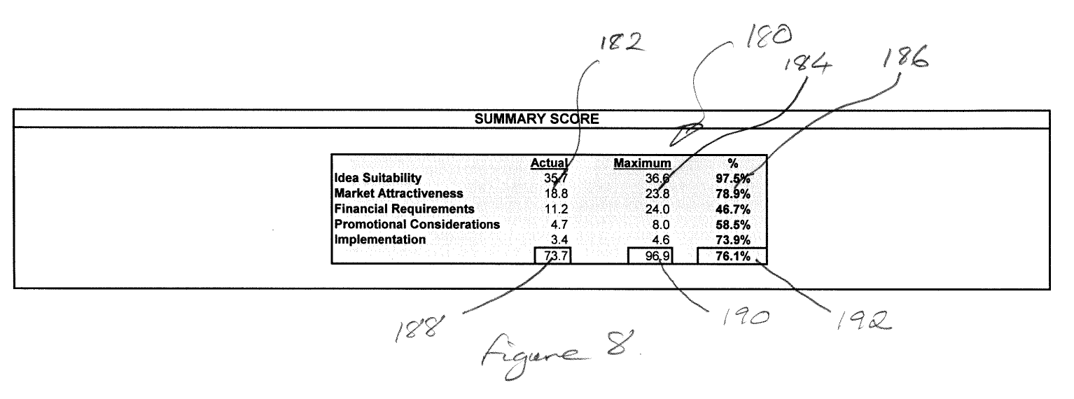

FIG. 8 shows in summary form the result 180 of combining the scores for the plurality of questions answered by the user. This step constitutes the next stage in the evaluation 60 performed by the server apparatus 12. The scores for the questions answered by the user are summed within each category to provide a category score for each category. Thus, ‘market attractiveness’ to which the first question belongs has according to the example shown in FIG. 8 an actual category score of ‘18.8%’ 182 as given in the first column of the table 180. The next column of FIG. 8 shows the maximum possible category score 184 that can be achieved for this category, namely ‘23.8%’ and the third column 186 shows the actual category score as a percentage of the maximum category score, namely ‘78.9%’. All the category scores are summed to provide an actual overall score 188, a maximum possible overall score 190 and an expression of the former as a percentage of the latter 192.

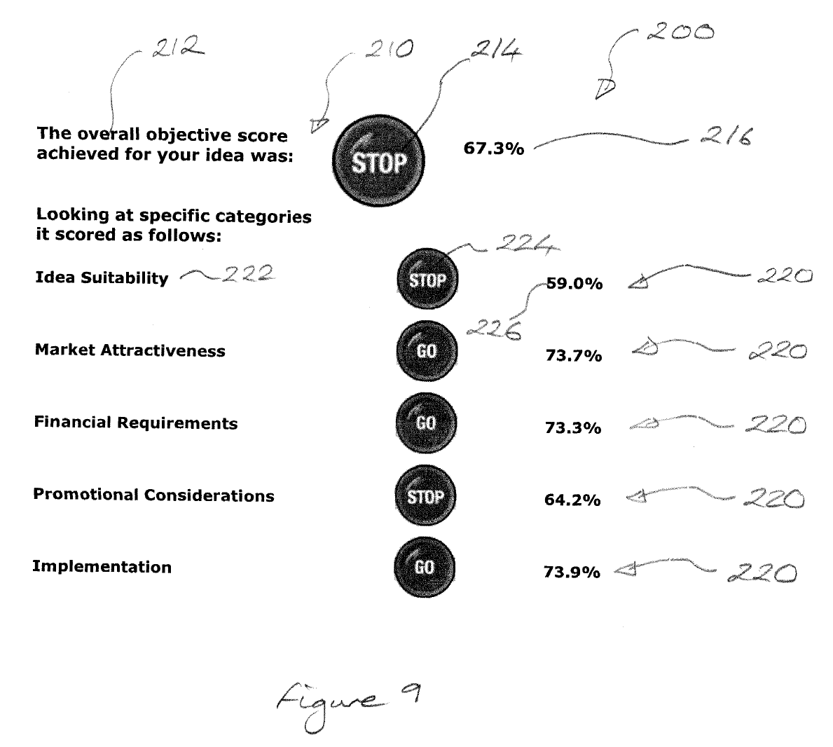

The step of providing a report to a user 62 is illustrated with reference to FIGS. 9 to 11. As described above, the evaluation is carried out on the answers by the server apparatus 12. The results of the evaluation illustrated in FIG. 8 are conveyed to the client apparatus 14 via the Internet 26 for display to the user on the display 24 in the form of a report. The results of the evaluation are conveyed to the client apparatus along with the necessary client processes to provide for the display of the report to the user.

FIG. 9 shows a first part 200 of the report as shown to the user on the display 24. The first element 210 (which constitutes an overall message) of the first part of the report consists of (reading from left to right): a title 212, namely ‘the overall objective score achieved for your idea (product) was’; an overall graphic 214 (which constitutes an assessment message) bearing the word ‘stop’; and an overall score 216, namely ‘67.3%’. The overall score 216 is as determined by the above described evaluation process and is the actual overall score 188 of FIG. 8 (although different actual overall scores are shown in FIGS. 8 and 9). The ‘stop’ word of the overall graphic 214 is selected in dependence on the actual overall score 216. In the present case an actual overall score of less than 70% causes the word ‘stop’ to be displayed; otherwise the word ‘go’ is displayed. Each of the following elements 220 of the first part of the report shown in FIG. 9 is also displayed to the user. Each following element (which constitutes a category message) is of the same general form. For example the first following element consists of (reading from left to right): a category title 222, namely ‘idea (product) suitability’; a category graphic 224 (which constitutes a category assessment message) bearing the word ‘stop’; and a category score 226, namely ‘59.0%’. The category score 226 is determined by the above described evaluation process for the category in question. As with the first element 210 described above, the word for the category graphic 224 for the first following element 220 is selected from the words ‘stop’ and ‘go’ depending on whether the category score is greater than or equal to 70% or is less than 70%.

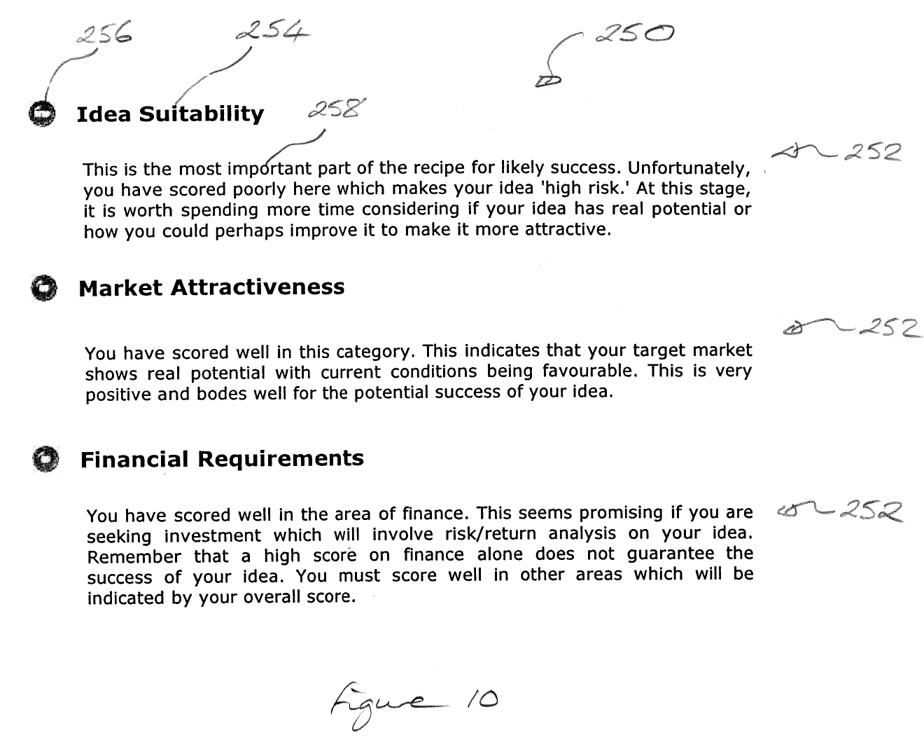

FIG. 10 shows a second part 250 of the report shown to the user on the display 24 as part of the step of providing a report to the user 64. The second part 250 of the report comprises an element 252 for each of three categories (only three categories are shown in FIG. 10 for the sake of clarity). Each element 252 comprises: a category title 254, which is the same as the category title of FIG. 9; a category graphic 256, which is the same as the category graphic of FIG. 9; and a category commentary 258. The category commentary conveys information on the category (in the present case the ‘idea suitability’ category) to the user. The information conveyed to the user is determined in dependence on the answers given by the user to the questions in the category in question. More specifically, the information conveyed includes an explanation of the category in question and comments on how the user may improve his current position as indicated by the category score 226 shown in FIG. 9.

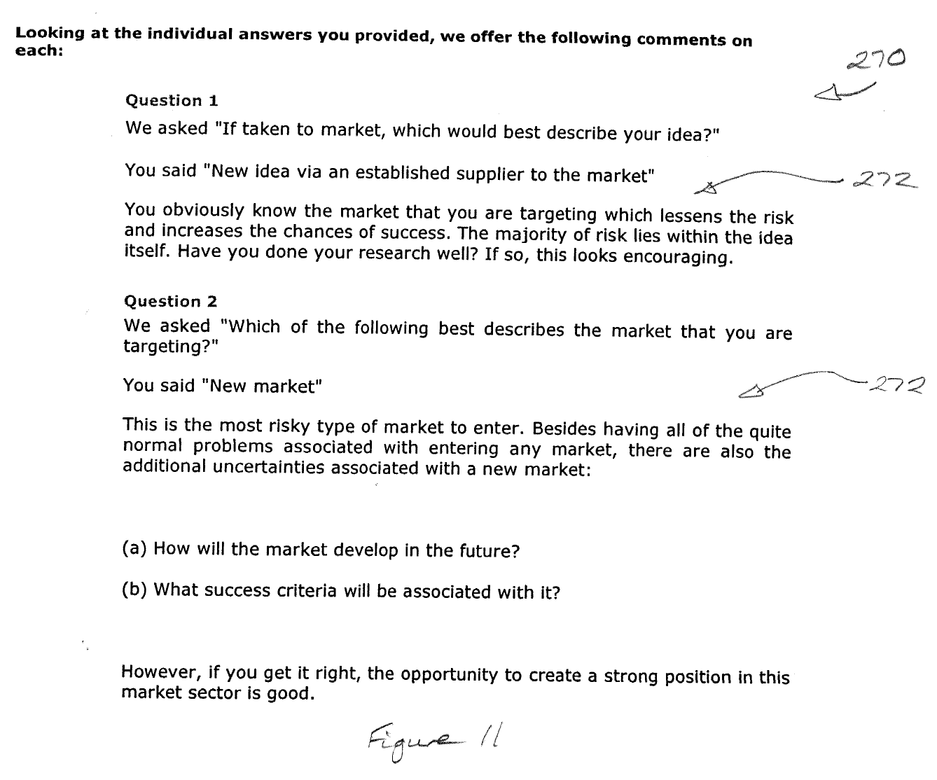

FIG. 11 shows a third part 270 of the report shown to the user. The third part 270 of the report comprises an element (which constitutes a question message) for each of the questions asked of the user. For the sake of clarity only the elements for the first two questions are shown in FIG. 11. Each element 272 is determined based on the answer given by the user to the question. More specifically, each element comprises: a statement of the question asked; a statement of the answer given by the user; and comments on how the user may improve his position as regards the characteristic of the product being evaluated to which the question relates.

In the present invention, the apparatus 10 is operative to form various data structures to enable the processes of the present invention to be executed. More specifically, an answer data structure, a question data structure and category data structure are formed. The answer data structure contains the plurality of different answers and the plurality of different answer weights as discussed above, with each of the plurality of different answers being associated in the answer data structure with a corresponding one of the plurality of different answer weights. The question data structure contains the plurality of different question weights which are associated with a respective one of the plurality of different questions. The category data structure comprises a plurality of sets of questions (e.g. a first set of questions and a second set of questions, each constituting a different category of questions), with each of the plurality of sets of questions comprising at least two questions. Such data structures are formed in accordance with the computer programming language employed and thus their formation will be evident to one skilled in the art.

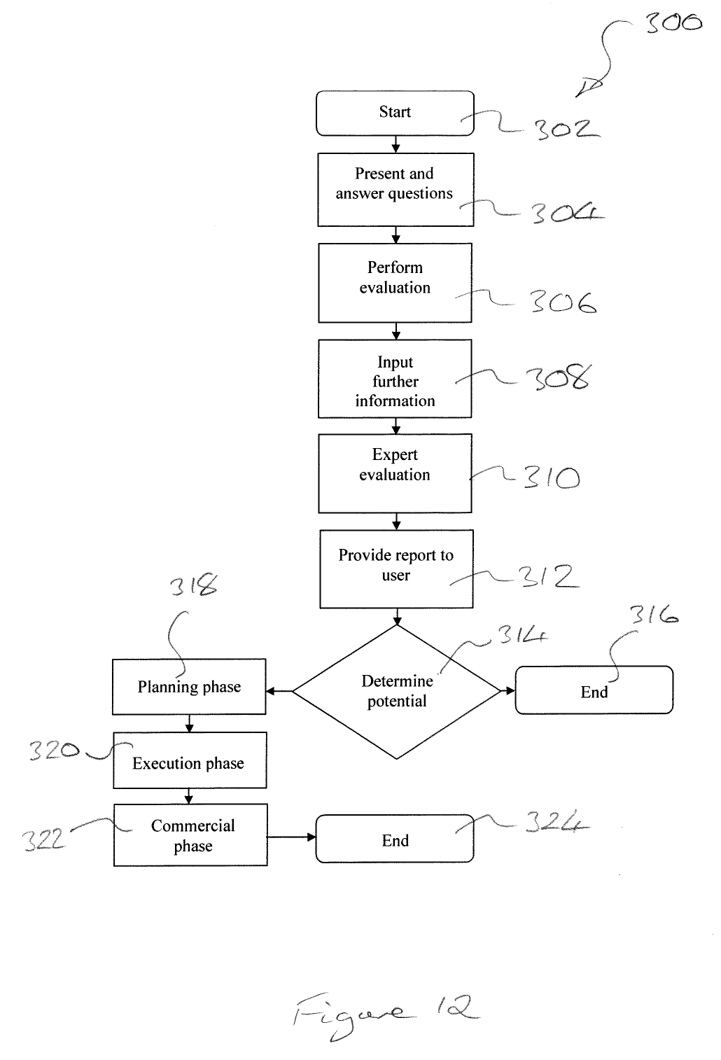

A flow chart representation of a method according to a second embodiment of the present invention 300 is shown in FIG. 12. The main procedural steps of the method are shown in FIG. 12. The second embodiment operates on the apparatus 10 for evaluating commercial prospects for a product illustrated in FIG. 1 and described above. Thus, the reader's attention is directed to FIG. 1 and the above accompanying description to gain an understanding of how the second embodiment operates. The first and second embodiments have many features in common as will become apparent from the following description.

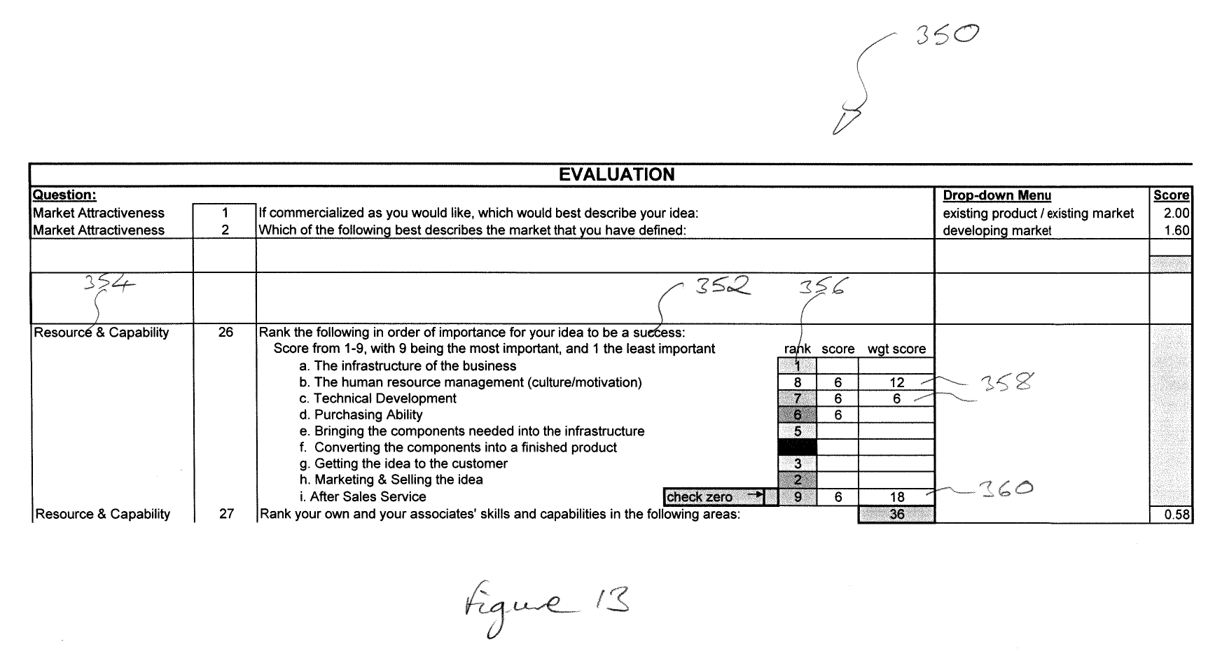

Referring now to the block diagram of the process shown in FIG. 12, the method begins 302 with the presentation and answering of questions 304. This step of the second embodiment is the same as the corresponding steps of the first embodiment, namely the repeated steps of presenting a question to the user 54 and the recording of the answer to the question 56, with the following exception described below with reference to FIG. 13. Next follows the step in FIG. 12 of performing the evaluation 306, which corresponds to the perform evaluation step 60 of the first embodiment. Thereafter the process follows steps that form no part of the method of the first embodiment. Further information (which constitutes recorded product information) is then input 308 to the client apparatus 14 or input directly to the server apparatus 12. Such further information relates to information not already gleaned from the process of presenting and answering questions 304. Such further information may include: detailed information relating to the status of intellectual property connected with the product under evaluation; information from a market foresighting report of relevance to the product under evaluation; and financial circumstances of a legal entity that will exploit the product under evaluation. Then the product being evaluated is subject to expert evaluation 310 by a person or more than one person having the appropriate expertise to evaluate the product or particular characteristics of the product. The person carries out his evaluation based on: the answers recorded by the method in response to the plurality of different questions presented to the user; and the further product information. The conclusion of the expert evaluation step is a personal score for the product being evaluated. On the conclusion of the evaluation by the person, the method progresses to the provision of a report to the user 312. The provision of the report to the user is as for the first embodiment as described above.

At the following step in FIG. 12 of determining the potential of the product 314, a decision is made as to whether the evaluation process concludes 316 or proceeds further. If the overall score from the evaluation process is less than 70% then the process concludes 316 with suggestions for improvement being provided to the user. If the overall score from the evaluation process is greater than or equal to 70% then the method proceeds to the planning phase 318. The planning phase 318 involves a face to face consultation with the user during which a review of the product is conducted. A decision is taken at the conclusion of the face to face consultation as to whether or not the process is taken further. If so, a commercial arrangement as regards the product is made between the user and another party, e.g. the proprietor of the method of the present invention as operated on the server apparatus 12 of FIG. 1. Thereafter and if appropriate, intellectual property rights relating to the product are considered. Furthermore, a plan for the commercial exploitation of the product is developed. The method then proceeds to the execution phase 320 during which there is at least one further face to face consultation with the user. In addition, financial aspects of the exploitation of the product are addressed, e.g. the sale in part or whole of the product to another party, the raising of funds, assistance with the raising of funds, etc. The strategy for commercial exploitation is also agreed upon. The method concludes with the commercial phase 322 during which the commercial exploitation of the product is carried out in accordance with the plan and strategy agreed earlier in the process.

As mentioned above, the step of presenting and answering questions 304 of the second embodiment shown in FIG. 12 is similar to that of the corresponding steps of the first embodiment. There are however some differences as follows. The second embodiment involves the asking and answering of a greater number of questions than the first embodiment. The intention of following this approach is to provide for an evaluation of greater depth than the evaluation of the first embodiment. In addition, the second embodiment involves asking questions of the kind illustrated in FIG. 13. FIG. 13 provides details of a small number of the plurality of different questions presented to the user (at step 304 in FIG. 12) following the completion of the preliminary procedure described above with reference to FIG. 3. The reader's attention is drawn to the 26^{th} question 352 (questions 3 to 25 having been omitted for the sake of clarity), namely “rank the following in order of importance for your idea (product) to be a success”. As can be seen from the left hand column the 26^{th} question belongs to the ‘resource & capability’ category 354. Instead of the first embodiment approach of selecting from a menu of possible answers, the user is asked to rank nine commercial features in order of importance by allocating a score 356 of between ‘1’ and ‘9’ (which constitutes a presented question score) to each feature. Each feature carries a weight which is used to provide a weighted score 358 for each feature with the weighted scores being added to determine a total weighted score 360 for all the features. This total weighted score is weighted by the category weight, as described above with reference to the first embodiment, to arrive at a question score. The thus determined question score is summed along with all the other question scores to determine the category score and all the category scores are summed to determine the overall score in accordance with the approach described above with reference to the first embodiment.

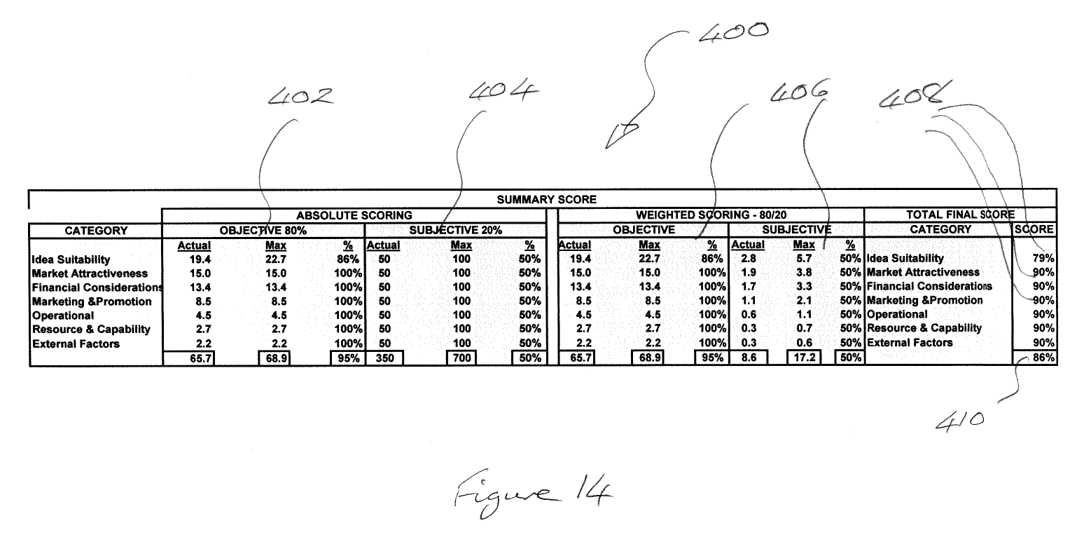

As mentioned above, the evaluation of the answers provided in response to the plurality of questions is the same for the second embodiment as the first embodiment. The overall score thereby produced is combined with the personal score given by the person during the expert evaluation step 310. How the overall and personal scores are combined and the impact on the report provided to the user will now be described with reference to FIG. 14.

The table 400 of FIG. 14 shows how the overall and personal scores are combined. The actual overall and the maximum possible scores 402 for a number of categories are shown towards the left hand side of the table 400. The next column specifies the actual personal and the maximum possible personal scores 404 for the same categories. In the next column all the figures specified in the overall and personal columns 402, 404 are weighted by 80% and 20% respectively 406. Then the weighted overall and personal scores are summed to provide a combined category score for each category 408. The combined category scores are then summed to provide a combined overall score 410. It is the combined category scores 408 and the combined overall score 410 that are used in providing a report to the user 312, as described above for the first embodiment with reference to FIGS. 9 to 11.

1. A method of evaluating commercial prospects for a product, the method comprising the steps of:
presenting a plurality of questions to a user of the method, each question reflecting a different characteristic of the product being evaluated;
recording an answer given by the user to each question;
weighting each recorded answer differently; and
providing an evaluation of the product to the user, the evaluation being based on the plurality of differently weighted answers.

2. A method according to claim 1 further comprising assigning a number to each recorded answer and in which the step of weighting each recorded answer differently comprises multiplying the number assigned to a recorded answer by a numerical weight.

3. A method according to claim 1, in which the step of providing an evaluation of the product to the user comprises summing the plurality of differently weighted answers.

4. A method according to claim 1, in which the step of presenting a plurality of questions comprises presenting a plurality of different answers to the user for each of the presented questions and in which the method further comprises recording a selected one of the plurality of different answers.

5. A method according to claim 4, in which the plurality of different answers have respective, different answer weights.

6. A method according to claim 4, in which the question to which the plurality of different answers relate has a question weight.

7. A method according to claim 6, in which each question of the plurality of different questions has a different weight.

8. A method according to claim 6, in which the method further comprises multiplying an answer weight of a selected one of the plurality of different answers with the question weight to provide a question score for the question.

9. A method according to claim 8, in which the method comprises combining the plurality of question scores corresponding to the plurality of different questions to provide an overall score for the product.

10. A method according to claim 1, in which the step of presenting a plurality of questions comprises asking a user to enter a presented question score for a presented question, the entered presented question score being weighted by a presented question weight.

11. A method according to claim 10, in which the step of presenting a plurality of questions comprises: asking a user to enter a presented question score for each of a plurality of presented questions; and summing the plurality of entered presented question scores.

12. A method according to claim 11, in which the summed presented question scores are weighted by a presented question weight.

13. A method according to claim 1, in which the step of presenting a plurality of questions comprise asking a user to enter a comparison score for at least one question relating to at least one competitor.

14. A method according to claim 13, in which the comparison score relates to at least one of: a competitor's product compared to the product under evaluation; and level of threat that a competitor presents in the marketplace.

15. A method according to claim 13, in which the comparison score is weighted by a comparison weight.

16. A method according to claim 1, in which the plurality of questions comprise a plurality of sets of questions, each of the plurality of sets of questions comprising at least two questions.

17. A method according to claim 16, in which the plurality of sets of questions are associated with respective, different categories of commercial characteristics.

18. A method according to claim 17, in which a category has a category weight and in which an answer to a question in a category is weighted by the category weight.

19. A method according to claim 1, in which the method further comprises processing a first answer to a first question and a second answer to a second question to thereby provide implicit information, the first question and the second question being related to each other such that their answers contain implicit information.

20. A method according to claim 19, in which the method comprises presenting a plurality of different answers to the user for each of the first and second questions and recording a selected one of the presented different answers and in which the step of processing the first selected answer and the second selected answer comprises determining an implied answer weight based on the first and second answers.

21. A method according to claim 20, in which the implied answer is determined on the basis of a look-up-table, the look-up-table having as a first axis the plurality of answers to the first question and as a second axis the plurality of answers to the second question.

22. A method according to claim 1, in which the step of providing an evaluation of the product to the user comprises providing an overall message to the user, the overall message being based on all answers provided by the user.

23. A method according to claim 22, in which the overall message comprises an overall score corresponding to prospects for commercial success of the product.

24. A method according to claim 23, in which the overall message comprises providing an assessment message informing the user as to whether or not to proceed with the product and in which the assessment message is determined based on the overall score.

25. A method according to claim 1, in which the step of providing an evaluation of the product to the user comprises providing a plurality of different category messages to the user, each category message being based on at least one weighted answer and each category message conveying information of a different commercial category to the user.

26. A method according to claim 25, in which the plurality of different category messages comprises at least one of: product suitability; market attractiveness; financial requirements; promotional considerations; and implementation.

27. A method according to claim 25, in which each of the plurality of different category messages is based on a different combination of answers provided by the user.

28. A method according to claim 25, in which a category message comprises a category score corresponding to prospects for commercial success of the product within the scope of the commercial category in question.

29. A method according to claim 28, in which the category message comprises providing a category assessment message informing the user as to whether or not to proceed with the product, the category assessment message being determined based on the category score.

30. A method according to claim 25, in which a category message comprises at least one of: a category title identifying a category to the user; and a category commentary conveying information on a category to the user, the category commentary being determined in dependence on at least one weighted answer.

31. A method according to claim 1, in which the step of providing an evaluation of the product to the user comprises providing a plurality of different question messages to the user, each question message being based on an answer and each question message conveying information relating to the question to the user.

32. A method according to claim 31, in which a question message comprises a question commentary conveying information to the user on an answer given to the question.

33. A method according to claim 32, in which the information conveyed by the question commentary comprises at least one of: a statement of the question asked and the answer given; comments on the answer given; and comments on how the user may improve his current position as regards the characteristic of the product under evaluation to which the question relates.

34. A method according to claim 1, in which the method further comprises the recording of product information further to that recorded by way of the answers recorded by the method in response to the plurality of different questions presented to the user.

35. A method according to claim 1, in which the method further comprises the step of having a person carry out an evaluation of the product.

36. A method according to claim 35, in which the method further comprises the recording of product information further to that recorded by way of the answers recorded by the method in response to the plurality of different questions presented to the user and in which the person carries out the evaluation based on at least one of: the answers recorded by the method in response to the plurality of different questions presented to the user; and recorded product information.

37. A method according to claim 35, in which the method further comprises the step of recording at least one personal score given by the person in dependence on the person's evaluation of the product.

38. A method according to claim 37, in which the at least one personal score comprises at least one of: a score in respect of at least one of the plurality of different questions presented to the user; a score in respect of at least one category of commercial characteristics; a score in respect of recorded product information.

39. A method according to claim 37, in which the method further comprises the step of weighting the recorded at least one personal score.

40. A method according to claim 39, in which where the recorded at least one personal score has a corresponding score determined by the method in dependence on an answer recorded in response to the plurality of questions presented to the user, the personal score and the corresponding score are weighted to different extents, the weighting for the corresponding score being greater than the weighting for the personal score.

41. A method according to claim 37, in which the step of providing an evaluation of the product to the user comprises providing an overall score to the user, the overall score comprising a combination of at least one personal score and at least one corresponding score.

42. An apparatus for evaluating commercial prospects for a product, the apparatus comprising a computer processor and computer memory, the computer memory storing a plurality of questions, each question reflecting a different characteristic of a product to be evaluated, the apparatus being operative under control of the computer processor to present each of the stored plurality of questions to a user of the apparatus and to record and store in the computer memory an answer given to each question by the user, the computer processor being operative to weight each of the stored answers differently and to provide an evaluation of the product for the user based on the plurality of differently weighted answers.

43. An apparatus according to claim 42 comprising a server apparatus and a client apparatus, the server apparatus and the client apparatus being spaced apart from each other, the server apparatus and the client apparatus being configured to communicate data between them.

44. An apparatus according to claim 43, in which the server apparatus comprises a server processor and server memory, the server memory storing the plurality of questions, the server apparatus being operative under control of the server processor to convey each of the stored questions to the client apparatus and to receive from the client apparatus and store in the server apparatus an answer given to each question by the user, the server processor being further configured to weight each of the stored answers differently and to convey an evaluation of the product to the client apparatus, the evaluation being based on the plurality of differently weighted answers and in which the client apparatus comprises a client processor, the client apparatus being operative under control of the client processor to present to the user each of the plurality of questions received from the server apparatus, to record the answer given to each question by the user, and to convey the recorded answers to the server apparatus, the client apparatus being further operative to receive an evaluation from the server apparatus and to provide the evaluation to the user.

45. A computer program comprising executable code that upon installation on a computer causes the computer to execute the procedural steps of:
presenting a plurality of questions to a user of the computer, each question reflecting a different characteristic of the product being evaluated;
recording an answer given by the user to each question;
weighting each recorded answer differently; and
providing an evaluation of the product to the user, the evaluation being based on the plurality of differently weighted answers.
